(19) United States
(12) Patent Application Publication
(10) Pub. No.: US 2005/0259752 A1
(43) Pub. Date: Nov. 24, 2005

(54) Apparatus for and method of image processing and output, and computer product

(75) Inventors: Tatsuaki Iwata, Kanagawa (JP); Atsushi Matsumura, Kanagawa (JP); Noboru Yamaguchi, Saitama (JP); Tomoya Kodama, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/948,134

(22) Filed: Sep. 24, 2004

(30) Foreign Application Priority Data
Mar. 30, 2004 (JP) 2004-101317

(51) Int. Cl. H04N 7/12; H04N 7/015; H04N 5/92

(52) U.S. Cl. 375/240.26; 386/112; 348/720

(57) ABSTRACT

An image processing apparatus includes a first image converter that performs a first image conversion on an original image and that obtains a converted image, a conversion information generator that generates conversion information determined based on a relationship between the original image and the converted image obtained by the first image converter, and a holding unit that holds the conversion information generated by the conversion information generator and the converted image subjected to the first image conversion while making the conversion information and the converted image correspond to each other.

### CROSS-REFERENCE TO RELATED APPLICATIONS

This application is based upon and claims the benefit of priority from the prior Japanese Patent Application No. 2004-101317 filed on Mar. 30, 2004; the entire contents of which are incorporated herein by reference.

### BACKGROUND OF THE INVENTION

1) Field of the Invention

The present invention relates to a technology for converting and output an image.

2) Description of the Related Art

Following development of digital broadcasting technology, a digital broadcast receiving environment has been improved. For example, the screen size and a resolution of a display unit of a television set for digital broadcast has increased.

Meanwhile, digital recording apparatuses such as a hard disk drive (HDD) recorder and a digital versatile disk (DVD) recorder have spread. Following the spread, the digital recording apparatus is sometimes used to record and store a high-resolution video image of a high-resolution digital television broadcast (a high-vision broadcast or HDTV) after being converted into a low-resolution video image of standard definition television (SDTV).

When the low-resolution video image of the SDTV or the like is encoded and recorded by the digital recording apparatus, the resolution of the video image is sometimes converted into a low resolution so as to improve coding efficiency. As a method of converting the resolution of the image into the low resolution, for example, it is know to reduce a horizontal resolution to a half or two-thirds.

However, if the video image is subjected to this resolution conversion, image quality is degraded due to an aliasing noise resulting from a signal processing for the resolution conversion. In addition, the resolution of the video image is sometimes converted again so as to play back the image that has been subjected to the resolution conversion and that has been stored. The image quality degradation also occurs due to a signal processing for the latter resolution conversion.

Techniques for improving the image quality degradation are conventionally known. Specifically, a technique for converting a low resolution of a video image into a high resolution, and thereby playing back a high-quality video image in a video image displaying apparatus is known (see, for example, Japanese Patent Application Laid-Open No. H10-145817). A technique for resolution conversion in a video image playing back apparatus is also known (see, for example, Japanese Patent Application Laid-Open No. 2002-311928).

According to the conventional techniques, however, the image quality degradation relating to image reproduction is corrected when the video image is played back, or the image quality degradation relating to video image display is corrected when the video image is displayed.

The correction processing is performed on the video image the resolution of which is reduced. Due to this, the correction target video image lacks in image quality degradation information before encoding such as information on a coding noise (e.g., a block noise or a deblock noise) contained in a high-resolution input bit stream before resolution conversion or that on a noise (e.g., an aliasing noise) that occurs when the resolution is converted from a high resolution into a low resolution. The image quality degradation information is, therefore, not I considered during the image quality correction.

### SUMMARY OF THE INVENTION

It is an object of the present invention to solve at least the problems in the conventional technology.

An image processing apparatus according to one aspect of the present invention includes a first image converter that performs a first image conversion on an original image, a conversion information generator that generates conversion information determined based on a relationship between the original image and a converted image subjected to the first image conversion, and a holding unit that holds the conversion information generated by the conversion information generator, and the converted image subjected to the first image conversion while making the conversion information and the converted image correspond to each other.

An image output apparatus according to another aspect of the present invention includes an acquiring unit that acquires conversion information determined based on a relationship between an original image and a converted image obtained by performing an image processing on the original image, and the converted image, an image converter that performs an image conversion on the converted image acquired by the acquiring unit using the conversion information acquired by the acquiring unit, and that obtains an output image, and an output unit that outputs the output image subjected to the image conversion.

An image processing method according to still another aspect of the present invention includes acquiring a converted image by performing a first image conversion on an original image, generating conversion information determined based on a relationship between the original image and the converted image subjected to the first image conversion, and holding the conversion information generated and the converted image subjected to the first image conversion while making the conversion information and the converted image correspond to each other.

An image output method according to still another aspect of the present invention includes acquiring conversion information determined based on a relationship between an original image and a converted image obtained by performing an image processing on the original image, and the converted image, obtaining an output image by performing an image conversion on the converted image using the conversion information acquired, and output the output image subjected to the image conversion.

A computer program product according to still another aspect of the present invention, having a computer readable medium including programmed instructions, wherein the instructions, when executed by a computer, cause the computer to perform acquiring a converted image by performing a first image conversion on an original image, generating conversion information determined based on a relationship between the original image and the converted image subjected to the first image conversion, and holding the conversion information generated and the converted image subjected to the first image conversion while making the conversion information and the converted image correspond to each other.

A computer program product according to still another aspect of the present invention, having a computer readable medium including programmed instructions, wherein the instructions, when executed by a computer, cause the computer to perform acquiring conversion information determined based on a relationship between an original image and a converted image obtained by performing an image processing on the original image, and the converted image, obtaining an output image by performing an image conversion on the converted image using the conversion information acquired, and output the output image subjected to the image conversion.

The other objects, features, and advantages of the present invention are specifically set forth in or will become apparent from the detailed description of the invention when read in conjunction with the accompanying drawings.

### BRIEF DESCRIPTION OF THE DRAWINGS

FIG. 1 is an overall configuration of a video image recording and playing back apparatus according to a first embodiment of the present invention;

FIG. 2 is a block diagram of detailed functional configurations of a converter and a playing back unit;

FIG. 3 is a flowchart of a processing performed by the video image recording and playing back apparatus according to the first embodiment;

FIG. 4 is a flowchart of a detailed recording video image generating processing performed by the converter;

FIG. 5 is a flowchart of a detailed conversion information generating processing performed by the converter;

FIG. 6 is a flowchart of a detailed video image output processing performed by the playing back unit;

FIG. 7 is a hardware configuration of the video image recording and playing back apparatus according to the first embodiment;

FIG. 8 is a functional configuration of a video image recording and playing back apparatus according to a second embodiment of the present invention;

FIG. 9 is a flowchart of a conversion information generating processing performed by a converter according to the second embodiment;

FIG. 10 is a block diagram of a detailed functional configuration of a video image recording and playing back apparatus according to a third embodiment of the present invention;

FIG. 11 is a block diagram of a detailed functional configuration of a video image recording and playing back apparatus according to a fourth embodiment of the present invention;

FIG. 12 is an explanatory view of a processing for burying conversion information into a recording bit stream; and

FIG. 13 is an overall configuration of an image processing system according to a fifth embodiment of the present invention.

### DETAILED DESCRIPTION

Exemplary embodiments of an image processing apparatus, an image output apparatus, an image processing method, an image output method, and a computer program product relating to the present invention will be explained in detail below with reference to the accompanying drawings. However, it should be noted that the present invention is not limited by these embodiments.

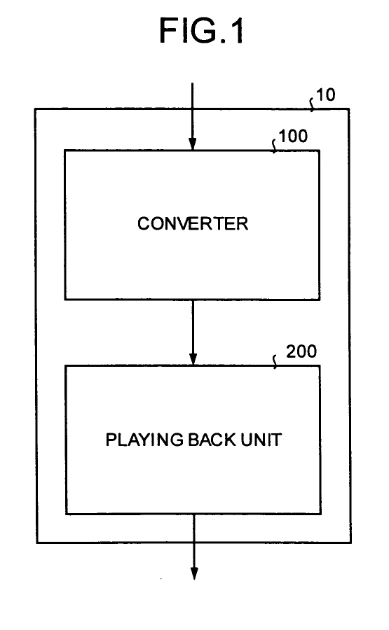

FIG. 1 is an overall configuration of a video image recording and playing back apparatus 10 according to the first embodiment of the present invention. The video image recording and playing back apparatus 10 includes a converter 100 and a playing back unit 200. The converter 100 acquires an input video image from an outside, converts a resolution of the input video image, and stores the resolution-converted video image. The playing back unit 200 plays back the resolution-converted video image stored in the converter 100.

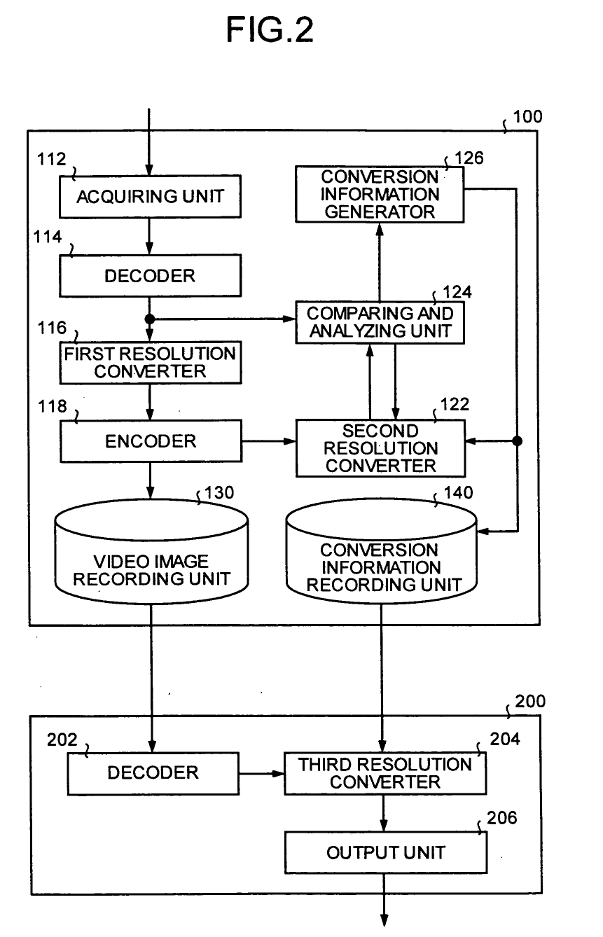

FIG. 2 is a block diagram of detailed functional configurations of the converter 100 and the playing back unit 200. The converter 100 includes an acquiring unit 112, a decoder 114, a first resolution converter 116, an encoder 118, a recording video image recording unit 130, a second resolution converter 122, a comparing and analyzing unit 124, a conversion information generator 126, and a conversion information recording unit 140. The recording video image recording unit 130 and the conversion information recording unit 140 according to this embodiment constitute a holding unit according to the present invention.

The acquiring unit 112 acquires the video image from the outside. The video image acquired by the acquiring unit 112 is an image obtained by encoding an original video image according to a first coding scheme. Examples of the first coding scheme include Motion Picture Expert Group 2 (MPEG-2), Motion Picture Expert Group 4 (MPEG-4), and H.264 Advanced Video Coding (H.264).

The acquiring unit 112 acquires the video image in the form of a bit stream. Specific examples of the bit stream include a transport stream of a digital broadcast, and a bit stream externally input by using Institute of Electrical and Electronics Engineers (IEEE) 1394 or the like.

The video image recording and playing back apparatus 10 according to the first embodiment is suitable for an apparatus that includes a digital tuner, or an apparatus that acquires the video image as the bit stream according to IEEE1394 or the like.

The decoder 114 acquires the bit stream from the acquiring unit 112. The decoder 114 decodes the acquired bit stream, and generates an original frame image.

The first resolution converter 116 acquires the original frame image from the decoder 114. The first resolution converter 116 performs resolution conversion on the acquired original frame image, and generates a recording frame image. Specifically, the first resolution converter 116 converts the resolution of the original frame image from a low resolution into a high resolution. In other words, the first resolution converter 116 according to the first embodiment performs the resolution conversion from a high definition (HD) resolution into a standard definition (SD) resolution.

The first resolution converter 116 may also reduce the aliasing noise or the like using a low-pass filter or the like. The first resolution converter 116 may hold information on the filter employed when performing the resolution conversion. If the filter information is held, the filter information may be used when conversion information, to be explained later, is generated.

A resolution converting processing performed by the first resolution converter 116 may be for converting an aspect ratio, dots-per-inch (dpi), or vertical size and horizontal size of image. The resolution converting processing may also be for converting either one of vertical size and horizontal size of image. As can be seen, it suffices that the resolution converting processing is for converting the resolution of the image by an image processing, and a content of the resolution converting processing is not limited to that explained in this embodiment.

The encoder 118 acquires the recording frame image obtained by the resolution conversion processing from the first resolution converter 116. The encoder 118 encodes the acquired low-resolution frame image according to a second coding scheme, and acquires a recording video image in the form of a bit stream.

The second coding scheme is different from the first coding scheme according to which the video image acquired by the acquiring unit 112 from the outside has been encoded. For example, if the first coding scheme is MPEG-2, the second coding scheme may be MPEG-4.

The recording video image recording unit 130 records the recording video image acquired from the encoder 118. The recording video image recording unit 130 records the low-resolution bit stream as the bit stream encoded by the encoder 118.

The second resolution converter 122 acquires the recording video image generated by the encoder 118. The second resolution converter 122 decodes the recording video image according to the second coding scheme, and converts the resolution of the decoded frame image so as to obtain a comparison frame image.

The second resolution converter 122 can perform the resolution conversion under different converting conditions. That is, the resolution converter 122 can acquire a plurality of different comparison frame images from one recording frame image. The converting conditions that can be used include, for example, a filter coefficient matrix and a weight factor. They also include an aliasing noise reduction filter coefficient used during the resolution conversion.

If the second coding scheme for generating a local decoded image is adopted in the coding processing performed by the encoder 118, the second resolution converter 122 may acquire the local decoded image from the encoder 118, and convert the local decoded image into the comparison frame image. The coding scheme for generating the local decoded image is, for example, MPEG-2.

The comparing and analyzing unit 124 acquires the comparison frame image from the second resolution converter 122 and also acquires the image, the resolution of which is not converted into the lower resolution, i.e., the original frame image from the decoder 114. The comparing and analyzing unit 124 compares the comparison frame image with the original frame image. Specifically, the comparing and analyzing unit 124 evaluates a difference in image quality between the both images.

As an index of evaluating the image quality difference, an image evaluation value is set, and the comparing and analyzing unit 124 evaluates the image quality difference based on the set image evaluation value. The image evaluation value may be set by using a least square error of each pixel of the image, an S/N ratio, or the like. The image evaluation value according to this embodiment corresponds to a similarity according to the present invention, and it is assumed that the greater the evaluation value is, the higher the similarity becomes.

As can be seen, the comparing and analyzing unit 124 can evaluate a degree of image quality degradation of the original frame image resulting from the processing such as the resolution conversion, by evaluating the similarity between the both images.

The comparing and analyzing unit 124 determines conversion information to be used when the corresponding recording frame image is played back, based on a comparison result. Specifically, if the image evaluation value for the original frame image and the comparison frame image is equal to or greater than a preset threshold, the comparing and analyzing unit 124 selects conversion information on the comparison frame image. That is, if the original frame image is similar in image quality to the comparison frame image, the comparing and analyzing unit 124 sets a conversion condition for converting the frame image into the comparison frame image as the conversion information.

By using the conversion information thus determined, a high-quality video image can be played back.

The conversion information generator 126 records the conversion information selected by the comparing and analyzing unit 124 on the conversion information recording unit 140 so as to be able to recognize the corresponding recording frame image. Specifically, the conversion information generator 126 may record the selected conversion information on the conversion information recording unit 140 so as to correspond to a recording frame image ID for identifying the recording frame image.

Alternatively, the conversion information generator 126 may determine conversion information used when the first resolution converter 116 performs the resolution conversion as another conversion information to be used to play back a video image.

Furthermore, when recording the conversion information, the conversion information generator 126 may determine one piece of conversion information for each video image. Alternatively, the conversion information generator 126 may determine one piece of conversion information for each frame. It suffices that the conversion information and the video image have a one-to-one correspondence, and a minimum unit of video image to which the conversion information is made to correspond is not limited to those explained in this embodiment.

The conversion information generator 126 may determine one piece of conversion information for each stream. For example, the conversion information generator 126 determines the one piece of conversion information for a plurality of frames contained in a stream, and then determines information obtained by averaging the conversion information on the respective frames as the conversion information on the stream.

When recording a plurality of pieces of conversion information for one video image, the conversion information generator 126 may compress an information amount by recording only differential information among the respective pieces of conversion information, or it may compress the entire conversion information according to a code compression algorithm such as Zigzag Inline Package (ZIP).

The playing back unit 200 includes a decoder 202, a third resolution converter 204, and an output unit 206. The decoder 202 acquires the recording video image from the recording video image recording unit 130, and then decodes the recording video image to a bit stream so as to acquire a low-resolution playing back frame image.

The third resolution converter 204 acquires the conversion information from the conversion information recording unit 140 and acquires the low-resolution playing back frame image from the decoder 202. Using the conversion information, the third resolution converter 204 performs resolution conversion on the low-resolution playing back frame image, thereby acquires a high-resolution playing back frame image. The output unit 206 outputs the playing back frame image acquired by the third resolution converter 204 to the outside.

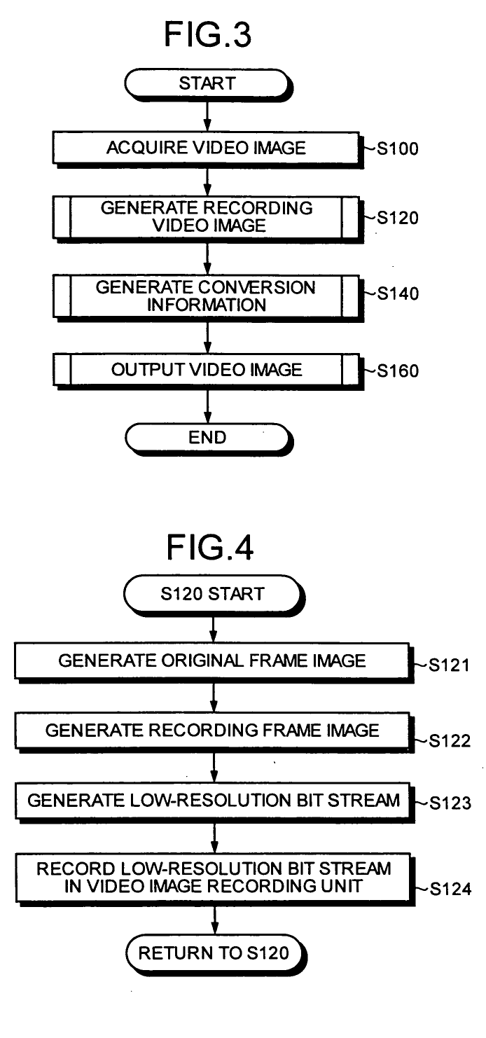

FIG. 3 is a flowchart of processing performed by the video image recording and playing back apparatus 10. The converter 100 acquires the original video image from the outside (at step S100), then obtains a lower-resolution recording video image from the acquired original video image (at step S102), and generates the conversion information to be used when the recording video image is played back (at step S104). During playing back, the playing back unit 200 generates the playing back frame image from the recording video image using the conversion information, and outputs the playing back frame image (at step S106).

FIG. 4 is a flowchart of detailed recording video image generating processing performed by the converter 100 at step S102 of FIG. 3.

The decoder 114 of the converter 100 first acquires the original video image from the acquiring unit 112, and decodes the original video image to the original frame image (at step S121). The first resolution converter 116 performs the resolution conversion on the original frame image, and generates the recording frame image (at step S122). The encoder 118 encodes the recording frame image, and generates the low-resolution bit stream (at step S123), and then records the generated low-resolution bit stream in the recording video image recording unit 130 (at step S124). The processing at the step S120 is thus completed, whereby the low-resolution bit stream to be stored is recorded.

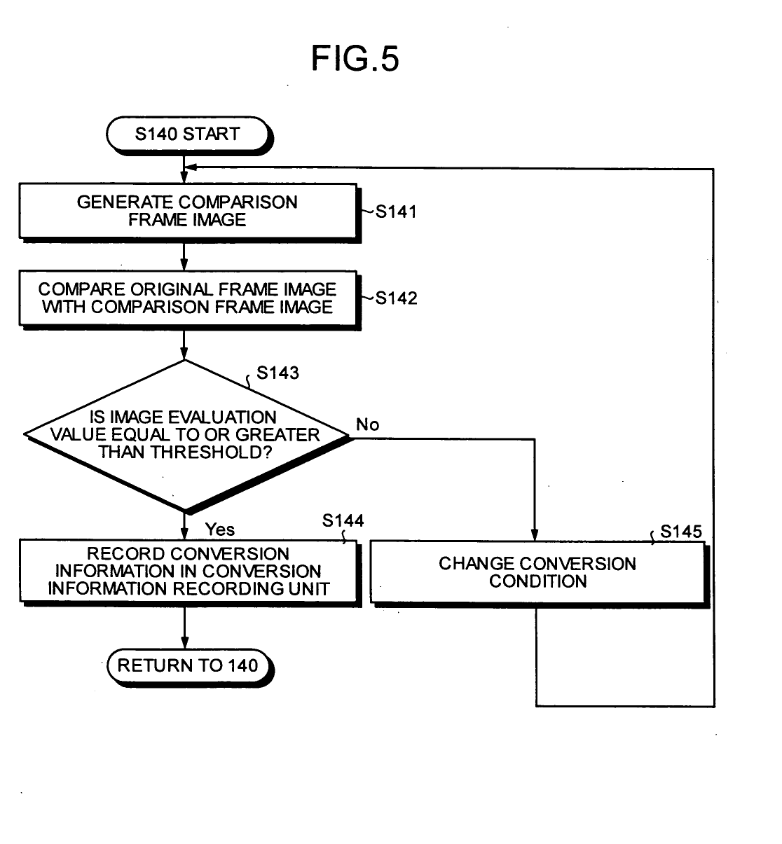

FIG. 5 is a flowchart of a detailed conversion information generating processing performed by the converter 100 at step S140 of FIG. 3.

The second resolution converter 122 of the converter 100 generates the comparison frame image under the predetermined conversion condition using the filter coefficient matrix or the like (at step S141). The comparing and analyzing unit 124 acquires the original frame image from the decoder 114, and also acquires the comparison frame image from the second resolution converter 122, and compares the original frame image with the comparison frame image (at step S142).

If a comparison result indicates that the image evaluation value is equal to or greater than the preset threshold (“Yes” at step S143), the comparing and analyzing unit 124 transmits the conversion condition used to generate the comparison frame image to the conversion information generator 126 as the conversion information. The conversion information generator 126 records the conversion information received from the comparing and analyzing unit 124 in the conversion information recording unit 140 so as to be able to recognize the corresponding recording frame image (at step S144). The processing at the step S140 is thus completed.

At the step S143, the instance in which the image evaluation value is equal to or greater than the preset threshold corresponds to an instance in which a difference between the original frame image and the comparison frame image, i.e., the degree of the image quality degradation resulting from the resolution conversion or the like is equal to or smaller than a certain value. Therefore, if the image evaluation value is equal to or greater than the preset threshold, the image quality degradation resulting from the resolution conversion or the like is within a tolerance amount.

If the comparison result of the comparing and analyzing unit 124 indicates that the image evaluation value is smaller than the preset threshold (“No” at step S143), the second resolution converter 122 changes the conversion condition used to generate the comparison frame image (at step S145) and generates again the comparison frame image under the changed conversion condition (at step S141). A series of processings are repeated until the image evaluation value equal to or greater than the threshold is obtained. This repetition processing may be wound up by a certain number of times K so as to reduce a processing cost. In addition, the video image unit to which the conversion information relates may be a unit for each recording frame image, a unit for each unit time, or a unit for an entire recording bit stream.

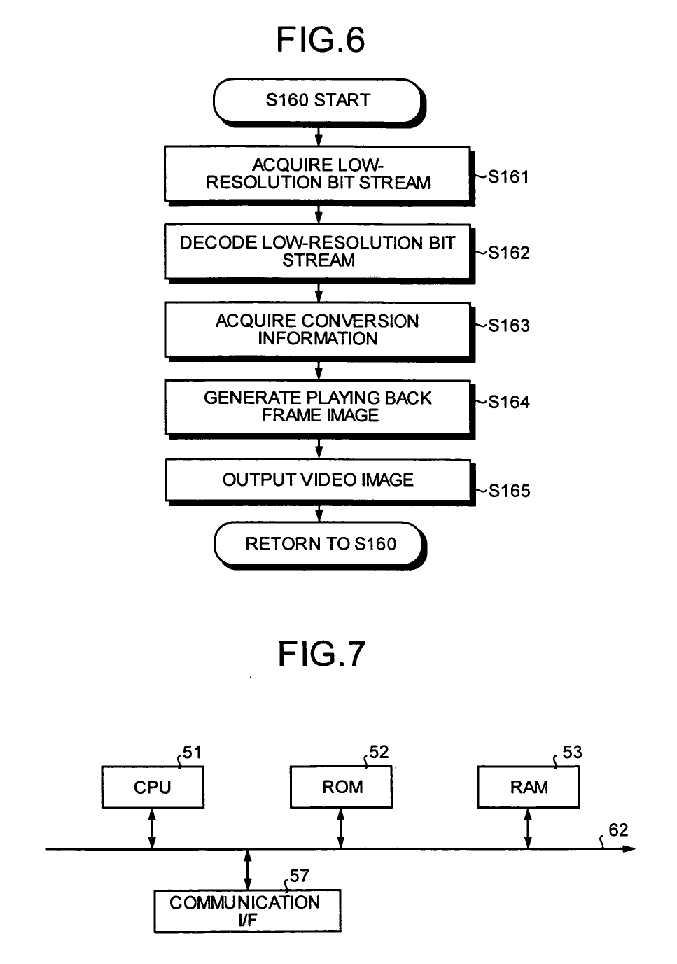

FIG. 6 is a flowchart of a detailed video image output processing performed by the playing back unit 200 at step S160 of FIG. 3.

When playing back the recording video image recorded in the recording video image recording unit 130, the decoder 202 of the playing back unit 200 first acquires the recording bit stream from the recording video image recording unit 130 (at step S161) and then decodes the recording bit stream and generates the low-resolution playing back frame image (at step S162). The third resolution converter 204 acquires the conversion information corresponding to the recording frame image acquired by the decoder 202 from the recording video image recording unit 130, from the conversion information recording unit 140 (at step S163).

The third resolution converter 204 generates the playing back frame image to be output to the outside, from the low-resolution playing back frame image using the conversion information (at step S164). The output unit 206 outputs the generated playing back frame image to the outside (at step S165). The processing at the step S160 is thus completed.

As can be understood, according to this embodiment, the video image can be played back using the conversion information. Therefore, even if the input video image is recorded after being subjected to resolution conversion, the video image can be played back with a high image quality similar to that of the input video image.

Furthermore, if the present embodiment is applied to a high-resolution video image of a digital broadcast or the like, the video image is stored after the resolution of the video image is converted from the high resolution into the low resolution and therefore, the high-quality video image can be recorded even at a low bit rate. In addition, a storage capacity can be saved.

Since the video image can be recorded after being subjected to conversion, the video image can be stored in various recording media as a backup. For example, the resolution of the high-resolution video image is converted into the low resolution, and the low-resolution video image can be stored, as a standard image quality, in a media (e.g., DVD) which can store the video image as a backup.

Moreover, when the low-resolution video image is displayed on a high-resolution video image displaying apparatus such as a large-screen television set, the video image can be displayed while maintaining the image quality of the original video image by using the conversion information.

Since the playing back unit 200 performs the resolution converting processing, the high-quality video image can be displayed without dependence on an image converting processing performance of the high-resolution video image displaying apparatus.

In addition, since the conversion information is generated based on the result of the comparison between the original frame image and the comparison frame image, the conversion information without dependence on the coding scheme, according to which the video image is encoded, can be generated. By thus using such conversion information, the high-quality video image can be played back, irrespectively of the coding scheme.

FIG. 7 is a hardware configuration of the video image recording and playing back apparatus 10 according to the first embodiment. As the hardware configuration, the video image recording and playing back apparatus 10 includes a read-only memory (ROM) 52 which stores an image processing program or the like for executing the image processing of the video image recording and playing back apparatus 10, a central processing unit (CPU) 51 that controls the respective constituent elements of the video image recording and playing back apparatus 10 according to the program stored in the ROM 52, and that executes a buffering time changing processing and the like, a random-access memory (RAM) 53 in which a work area is formed, and which stores various pieces of data necessary to control the video image recording and playing back apparatus 10, a communication interface (I/F) 57 connected to a network for communication, and a bus 62 which connects the respective constituent elements of the apparatus 10 to one another.

The image processing program stored in the video image recording and playing back apparatus 10 may be provided by recording the program in a computer readable recording medium such as a CD-ROM, a floppy disk (FD), or a DVD in an installable format or an executable format.

If the image processing program is recorded in such medium, the image processing program is loaded onto a main storage device by allowing the video image recording and playing back apparatus 10 to read the image processing program from the recording medium so as to execute it, and the respective units explained as the software configuration are generated on the main storage device.

The image processing program according to this embodiment may be provided by storing the program in a computer connected to a network such as the Internet, and downloading the program via the network.

While the first embodiment of the present invention is explained so far, various changes and modifications can be made to the first embodiment.

According to a first modification of the first embodiment, the second resolution converter 122 may determine the conversion condition based on the condition under which the first resolution converter 116 performs the resolution conversion. Specifically, the second resolution converter 122 generates the comparison frame image under the conversion condition closest to the condition for the resolution conversion performed by the first resolution converter 116. By thus predicting the conversion condition, processing efficiency can be enhanced.

According to the first embodiment, the first resolution converter 116 performs the resolution conversion from the HD resolution into the SD resolution. According to a second modification of the first embodiment, the first resolution converter 116 may perform the resolution conversion from the SD resolution into a half SD resolution. The type of the resolution conversion is not limited to that explained in the first embodiment.

The video image recording and playing back apparatus 10 may further record the recording image that has been subjected to the resolution conversion from the low resolution into the high resolution, after encoding the recording image. Specifically, the acquiring unit 112 may acquire the low-resolution video image of an analog television broadcast or the like from the outside. Then the first resolution converter 116 may perform the resolution conversion for converting this low-resolution video image into a high-resolution video image of HDTV, and record the high-resolution bit stream obtained by the conversion in the recording video image recording unit 130.

With this configuration, the second resolution converter 122 converts the resolution of high-resolution bit stream into the low resolution. The comparing and analyzing unit 124 compares the comparison frame image corresponding to the bit stream the resolution of which is converted into the low resolution, with the original frame image. The conversion information generator 126 generates conversion information on the resolution conversion from the high resolution into the low resolution based on the comparison result of the comparing and analyzing unit 124.

During playing back, the third resolution converter 204 converts the resolution of the recording frame image from the high resolution into the low resolution using the conversion information. The output unit 206 outputs the low-resolution video image. If the output unit 206 outputs the high-resolution video image without processing it, the output unit 206 may output a decoded high-resolution bit stream as it is.

As can be understood, the video image can be stored after converting the resolution of the video image from the low resolution into the high resolution. Therefore, the resolution of the low-resolution video image of a terrestrial analog broadcast or the like can be converted into the high resolution, and the resultant high-resolution video image can be stored in the media which can store this video image as a backup.

According to the first embodiment, the decoder 114 and the first resolution converter 116 are provided separately. According to a third modification of the first embodiment, the decoder 114 and the first resolution converter 116 may be provided integrally when a decoding scheme for performing decoding and resolution conversion simultaneously is adopted.

According to a fourth modification of the first embodiment, the decoder 114 may perform a processing using a deblocking filter or a post filter so as to improve the image quality of the decoded image of the acquired bit stream.

According to the fourth modification, the decoder 114 may inform the conversion information generator 126 of a content of the decode processing, and the conversion information generator 126 may generate the conversion information based on the content of the decode processing performed by the decoder 114.

It is thereby possible to generate the conversion information which enables playing back a higher-quality video image. The conversion information referred to herein is information that indicates the processing for enabling the video image that has been processed by the decoder 114 to be played back during playing back.

According to a fifth modification of the first embodiment, the second coding scheme may be equal to the first coding scheme.

According to the first embodiment, the second resolution converter 122 performs the resolution conversion processing after decoding the image encoded by the encoder 118. According to a sixth modification of the first embodiment, the second resolution converter 122 may adopt a decoding scheme for performing decoding and resolution conversion simultaneously.

The video image recording and playing back apparatus 20 according to a second embodiment will be explained. The video image recording and playing back apparatus 20 according to the second embodiment selects optimum conversion information, and records the conversion information in the conversion information recording unit 140. The video image recording and playing back apparatus 20 according to the second embodiment differs in this respect from that according to the first embodiment that selects the conversion information corresponding to the evaluation value equal to or greater than the threshold.

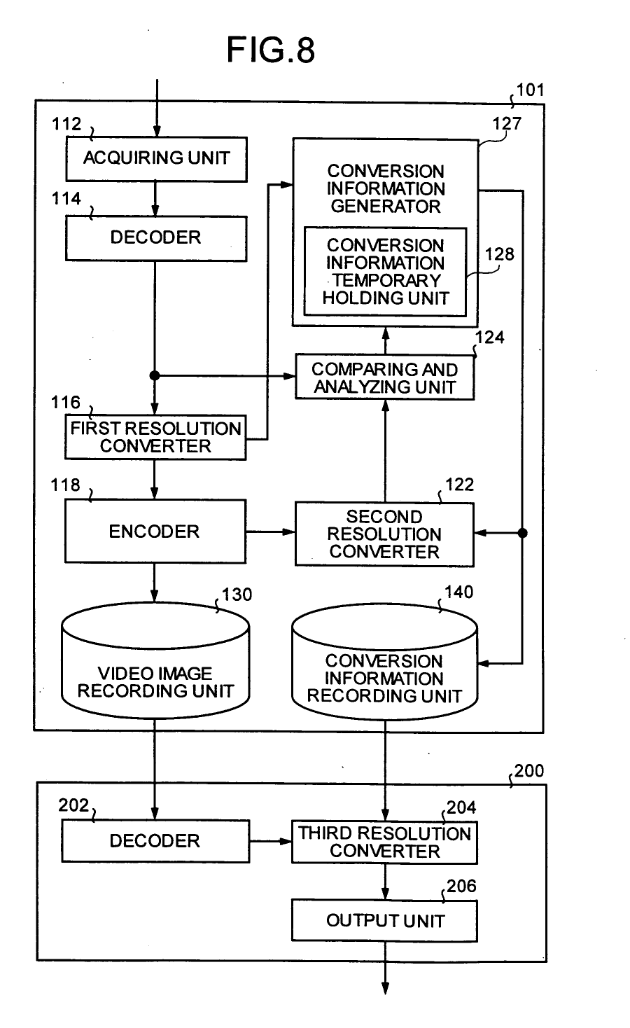

FIG. 8 is a functional configuration of the video image recording and playing back apparatus 20 according to the second embodiment. The conversion information generator 127 of a converter 101 of the video image recording and playing back apparatus 20 according to the second embodiment includes a conversion information temporary holding unit 128.

The second resolution converter 122 according to the second embodiment generates a plurality of comparison frame images under a plurality of preset conversion conditions, respectively. The comparing and analyzing unit 124 compares the comparison frame images generated by the second resolution converter 122 with the original frame image, and generates image evaluation values, respectively.

The conversion information temporary holding unit 128 of the conversion information generator 127 holds the image evaluation values generated by the comparing and analyzing unit 124 and the corresponding conversion conditions while making the image evaluation values correspond to one another.

The conversion information generator 127 compares the image evaluation values held in the conversion information temporary holding unit 128 with one another, and sets the conversion condition corresponding to the maximum image evaluation value as the conversion information. Namely, the conversion information generator 127 sets the conversion condition, under which the highest-quality video image can be played back, as the conversion information.

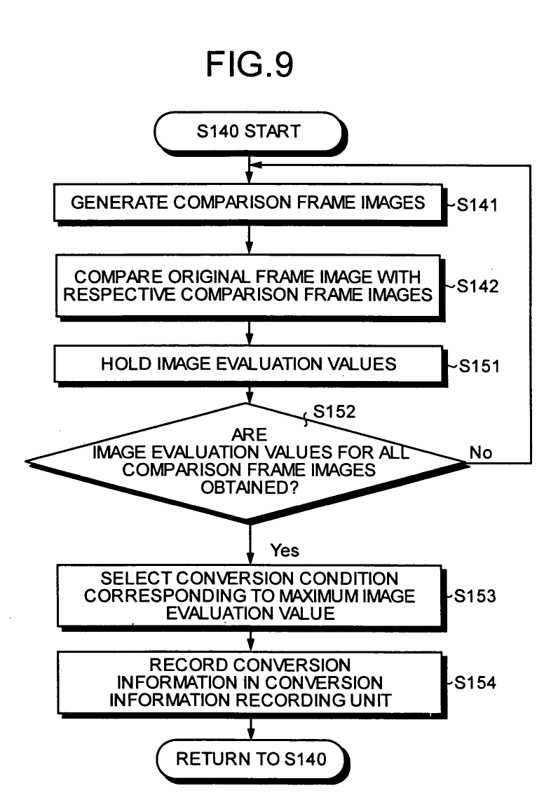

FIG. 9 is a flowchart of a conversion information generating processing performed by the converter 101 according to the second embodiment at step S140. In the converter 101 according to the second embodiment, the second resolution converter 122 generates the comparison frame images (at step S141). The comparing and analyzing unit 124 compares the original frame image with the respective comparison frame images (at step S142), and stores the image evaluation values obtained as a result of the comparison in the conversion information temporary holding unit 128 (at step S151).

The second resolution converter 122 holds a plurality of preset conversion conditions. The second resolution converter 122 repeats the processing until generating the comparison frame images from the same recording frame under all the conversion conditions held in the conversion information temporary holding unit 128, respectively (at step S152).

When conversion information temporary holding unit 128 holds the image evaluation values for the comparison frame images obtained under all the conversion conditions (“Yes” at the step S152), the conversion information generator 127 selects the conversion condition corresponding to the maximum image evaluation value among those held in the conversion information temporary holding unit 128 (at step S153). The conversion information generator 127 records, as the conversion information, the selected conversion condition in the conversion information recording unit 140 so as to be able to recognize the corresponding recording frame image (at step S154). The processing at the step S140 is thus completed.

The converter 101 according to the second embodiment can generate the optimum conversion information on each recording frame image. The conversion information optimization processing may be performed for each unit time or the entire recording bit stream, and corresponding conversion information may be generated.

The other configurations and the other processings of the video image recording and playing back apparatus 20 according to the second embodiment are the same as those of the video image recording and playing back apparatus 10 according to the first embodiment.

The video image recording and playing back apparatus 30 according to a third embodiment will be explained. The video image recording and playing back apparatus 30 according to the third embodiment acquires an original video image in the form of a video image, not a bit stream, from the outside.

The video image recording and playing back apparatus 10 according to the first embodiment is suited for an apparatus that includes, for example, a digital tuner. The video image recording and playing back apparatus 30 according to the third embodiment is suited for an apparatus that, for example, acquires an HD output screen of a Broadcasting Satellite (BS) digital tuner as an analog input by being connected to an external apparatus, encodes, and records the acquired HD output screen.

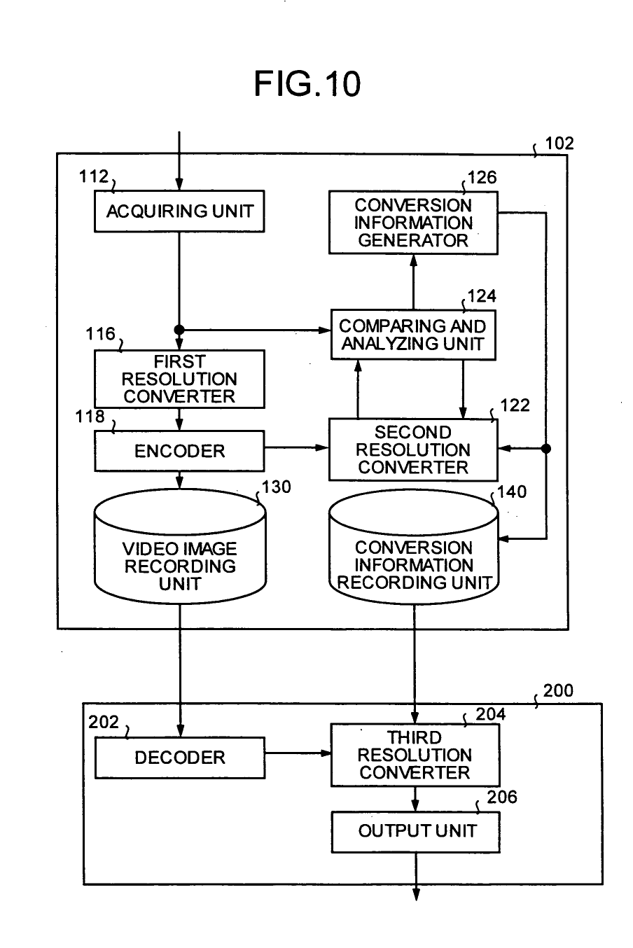

FIG. 10 is a block diagram of a detailed functional configuration of the video image recording and playing back apparatus 30 according to the third embodiment. Since the video image recording and playing back apparatus 30 according to the third embodiment acquires the original video image as the video image, the apparatus 30 does not include the decoder 114. In this respect, the converter 102 according to the third embodiment differs from those according to the first and the second embodiments. According to the third embodiment, the first resolution converter 116 acquires the original video image from the acquiring unit 112, and directly performs the resolution conversion on the original video image.

The other configurations and the other processings of the video image recording and playing back apparatus 30 according to the third embodiment are the same as those of the video image recording and playing back apparatus 10 according to the first embodiment.

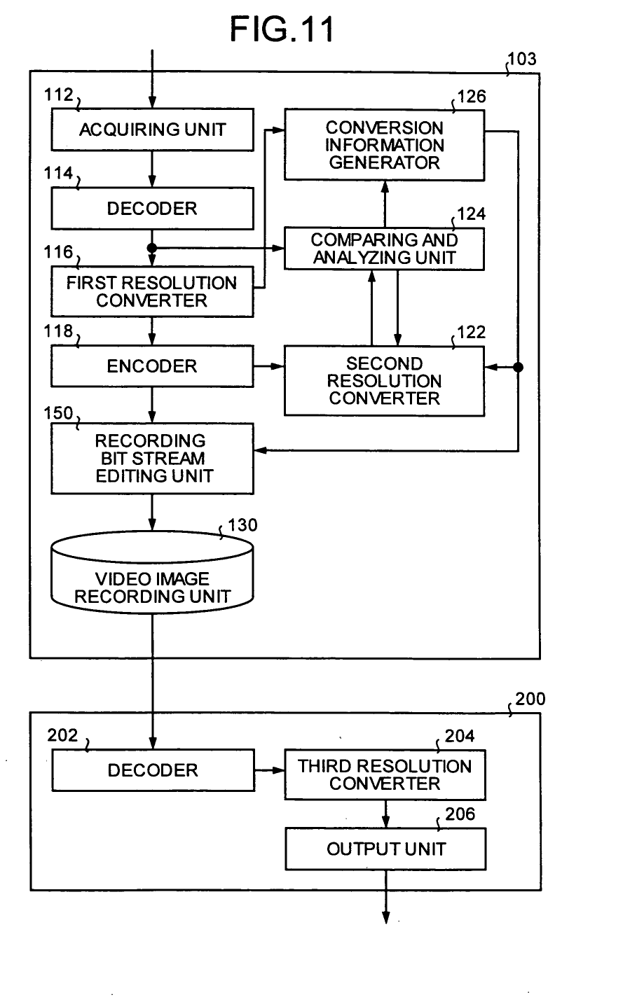

The video image recording and playing back apparatus 40 according to a fourth embodiment will be explained. The video image recording and playing back apparatus 40 according to the fourth embodiment stores conversion information and a recording bit stream while making them correspond to each other. The video image recording and playing back apparatus 40 according to the fourth embodiment differs in this respect from those according to the first, the second, and the third embodiments. FIG. 11 is a block diagram of a detailed functional configuration of the video image recording and playing back apparatus 40 according to the fourth embodiment. According to the fourth embodiment, the converter 103 further includes a recording bit stream editing unit 150 in the functional configuration of the converter 100 according to the first embodiment, but does not include the conversion information recording unit 140.

The recording bit stream editing unit 150 acquires a recording bit stream from the encoder 118 and also acquires the conversion information from the conversion information generator 126. The recording bit stream editing unit 150 buries the conversion information into the recording bit stream and records the recording bit stream buried with the conversion information in the recording video image recording unit 130.

In the playing back unit 200, the third resolution converter 204 acquires the conversion information buried in the recording bit stream from the decoder 202, and performs resolution conversion on the recording bit stream using the conversion information.

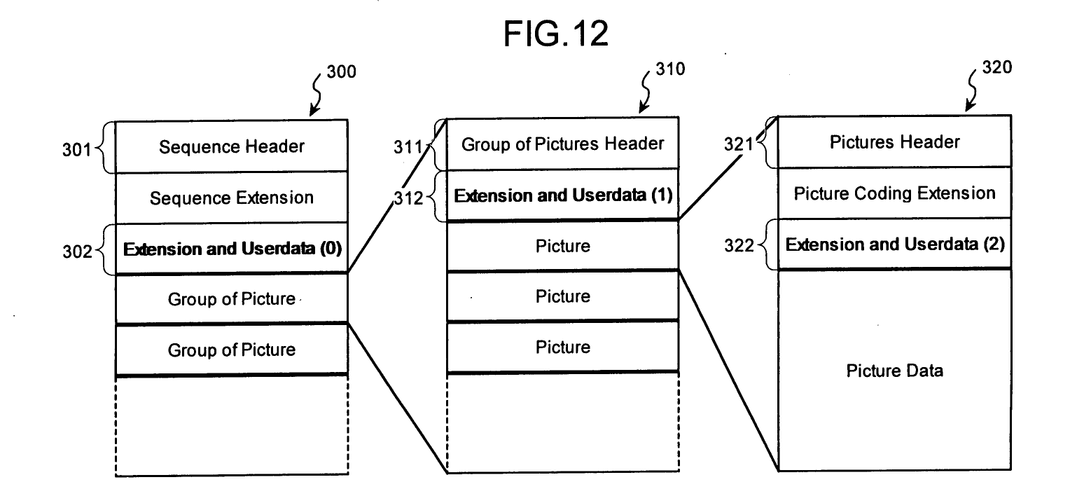

FIG. 12 is an explanatory view of the processing for burying the conversion information into the recording bit stream. FIG. 12 schematically depicts the recording video image according to MPEG-2. A sequence 300 according to MPEG-2, that is, a coding signal for the entire stream includes one or more groups of pictures (“GOP”) 310. Each GOP 310 includes one or more pictures 320.

According to MPEG-2, an area that stores extension information and user information (Extension and Userdata) can be inserted into a portion following each of headers 301, 311, and 321 in the sequence 300, the GOP 310, and the picture 320. The Extension and Userdata areas 302, 312, and 322 are user data areas that can be arbitrarily set by a user.

The recording bit stream editing unit 150 according to the fourth embodiment buries the conversion information into each of these areas. Since arbitrary data at an arbitrary data size can be inserted into each area, the recording bit stream editing unit 150 can freely bury the conversion information into the recording bit stream.

The conversion information may be buried into any one of the Extension and Userdata areas 302, 312, and 322. The area into which the conversion information is buried may be changed based on a processing ability of a system, a method of generating the conversion information, a quantity of generated codes, or the like.

The conversion information may be buried into all of the Extension and Userdata areas 302, 312, and 322. If one piece of conversion information is generated for the entire sequence, for example, the conversion information on the entire sequence is preferably buried into the Extension and Userdata area 302.

If the conversion information is generated for each picture, the conversion information on each picture is preferably buried into the Extension and Userdata area 322.

The other configurations and the other processings of the video image recording and playing back apparatus 40 according to the fourth embodiment are the same as those of the video image recording and playing back apparatus 10 according to the first embodiment.

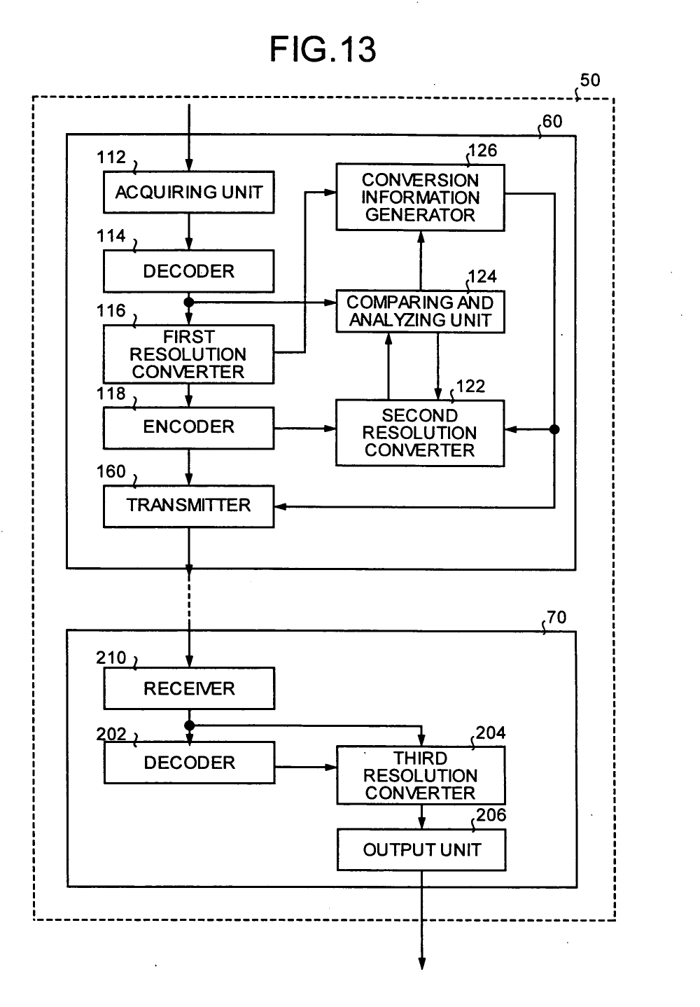

A fifth embodiment will be explained. FIG. 13 is an overall configuration of an image processing system 50 according to the fifth embodiment. In the fifth embodiment, the converter and the playing back unit are provided separately. Namely, the image processing system 50 according to the fifth embodiment includes a video image recording apparatus 60 and a video image playing back apparatus 70.

The video image recording apparatus 60 according to the fifth embodiment transmits a recording video image and conversion information to the video image playing back apparatus 70. The video image playing back apparatus 70, having received the recording video image and the conversion information, plays back the recording video image based on the conversion information.

Specifically, the video image recording apparatus 60 includes a transmitter 160 but does not include the recording video image recording unit 160 or the conversion information recording unit 140. The transmitter 160 receives the recording image from the encoder 118 and also the conversion information from the conversion information generator 126, and transmits the recording image and the conversion information to the video image playing back apparatus 70.

On the other hand, the video image playing back apparatus 70 further includes a receiver 210. The receiver 210 receives the recording image and the conversion information from the video image recording apparatus 60. The receiver 210 also transmits the recording image to the decoder 202, and transmits the conversion information to the third resolution converter 204. The third resolution converter 204 holds a resolution with which the video image playing back apparatus 70 can play back the video image. The third resolution converter 204 compares the reproducible resolution with the conversion information received from the video image recording apparatus 60, and determines an optimum conversion condition. The video image playing back apparatus 70 can thus play back a video image with the optimum resolution at an optimum image quality.

The other configurations and the other processings of the video image recording apparatus 60 are the same as those of the converter 100 according to the first embodiment. The other configurations and the other processings of the video image playing back apparatus 70 are the same as those of the playing back unit 200 according to the first embodiment.

According to the embodiments explained above, even if a processing such as a resolution conversion is performed on the image, each of the image processing apparatus and the image output apparatus according to the embodiments holds the conversion information to be used when the processed image is output. Therefore, by converting the processed image into an output image using the conversion information, it is advantageously possible to output an image having less image quality degradation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image processing apparatus comprising:
a first image converter that performs a first image conversion on an original image;
a conversion information generator that generates conversion information determined based on a relationship between the original image and a converted image subjected to the first image conversion; and
a holding unit that holds the conversion information generated by the conversion information generator, and the converted image subjected to the first image conversion while making the conversion information and the converted image correspond to each other.

2. The image processing apparatus according to claim 1, wherein the first image converter converts a resolution of the original image.

3. The image processing apparatus according to claim 1, wherein the conversion information generator generates the conversion information based on the original image and the converted image corresponding to the original image.

4. The image processing apparatus according to claim 1, wherein the conversion information generator generates the conversion information based on a content of a processing performed on the original image by the first image converter.

5. The image processing apparatus according to claim 1, further comprising:
a second image converter that performs a second image conversion on the converted image and generates a comparison image, the second image conversion being opposite to the first image conversion; and
a comparing unit that compares the comparison image generated by the second image converter with the original image, wherein
when the comparing unit determines that a similarity between the comparison image and the original image is equal to or higher than a certain value, the conversion information generator generates the conversion information based on a content of a processing performed by the second image converter.

6. The image processing apparatus according to claim 5, further comprising
a conversion condition changing unit that changes a conversion condition for the second image conversion performed by the second image converter when the comparing unit determines that the similarity between the comparison image and the original image is lower than the certain value, wherein when the conversion condition changing unit changes the conversion condition, the second image converter generates the comparison image under the changed conversion condition.

7. The image processing apparatus according to claim 5, further comprising
a conversion condition changing unit that changes a conversion condition for the second image conversion to be performed on the converted image by the second image converter based on the converted image subjected to the first image conversion by the first image converter, wherein
the second image converter generates the comparison image under the conversion condition changed by the conversion condition changing unit.

8. The image processing apparatus according to claim 5, further comprising
a conversion condition changing unit that changes a conversion condition for the second image conversion performed by the second image converter, wherein
the second image converter generates comparison images corresponding to a plurality of different conversion conditions changed by the conversion condition changing unit, respectively,
the comparing unit compares the comparison images generated by the second image conversion unit with the original image, respectively, and
the conversion information generator generates the conversion information under the conversion condition under which the similarity between one of the comparison images and the original image is highest.

9. The image processing apparatus according to claim 5, wherein
the original image is a video image,
the second image converter performs the second image conversion using a filter coefficient matrix, and
the conversion information generator generates the conversion information including information on the filter coefficient matrix used by the second image converter.

10. The image processing apparatus according to claim 9, wherein
the second image converter generates the conversion information including information on a weight factor allocated to the filter coefficient matrix.

11. The image processing apparatus according to claim 1, wherein
the first image converter performs the first image conversion for converting the resolution of the original image into a low resolution.

12. The image processing apparatus according to claim 1, wherein
the first image converter performs the first image conversion for converting the resolution of the original image into a high resolution.

13. The image processing apparatus according to claim 1, further comprising:
an acquiring unit that acquires the original image encoded according to a first coding scheme from an outside;
a decoder that decodes the original image acquired by the acquiring unit, according to the first coding scheme; and
an encoder that encodes the converted image corresponding to the original image decoded by the decoder, according to a second coding scheme different from the first coding scheme, wherein
the holding unit holds the converted image encoded by the encoder.

14. The image processing apparatus according to claim 1, further comprising:
an acquiring unit that acquires the original image encoded according to a predetermined coding scheme from an outside;
a decoder that decodes the original image acquired by the acquiring unit, according to the predetermined coding scheme; and
an encoder that encodes the converted image corresponding to the original image decoded by the decoder, according to a coding scheme equal to the first coding scheme, wherein
the holding unit holds the converted image encoded by the encoder.

15. The image processing apparatus according to claim 1, further comprising:
a third image converter that performs a third image conversion on the converted image held by the holding unit, using the conversion information made to correspond to the converted image, and that obtains an output image; and
an output unit that outputs the output image subjected to the third image conversion.

16. The image processing apparatus according to claim 1, wherein
the first image converter performs the first image conversion on an original image group that includes a plurality of images, and
the conversion information generator generates the conversion information on the original image group.

17. The image processing apparatus according to claim 1, wherein
the holding unit holds the conversion information while encapsulating the conversion information into the corresponding converted image.

18. An image output apparatus comprising:
an acquiring unit that acquires conversion information determined based on a relationship between an original image and a converted image obtained by performing an image processing on the original image, and the converted image;
an image converter that performs an image conversion on the converted image acquired by the acquiring unit using the conversion information acquired by the acquiring unit, and that obtains an output image; and
an output unit that outputs the output image subjected to the image conversion.

19. An image processing method comprising:
acquiring a converted image by performing a first image conversion on an original image;
generating conversion information determined based on a relationship between the original image and the converted image subjected to the first image conversion; and
holding the conversion information generated and the converted image subjected to the first image conversion while making the conversion information and the converted image correspond to each other.

20. An image output method comprising:
acquiring conversion information determined based on a relationship between an original image and a converted image obtained by performing an image processing on the original image, and the converted image;
obtaining an output image by performing an image conversion on the converted image using the conversion information acquired; and
output the output image subjected to the image conversion.

21. A computer program product having a computer readable medium including programmed instructions, wherein the instructions, when executed by a computer, cause the computer to perform:
acquiring a converted image by performing a first image conversion on an original image;
generating conversion information determined based on a relationship between the original image and the converted image subjected to the first image conversion; and
holding the conversion information generated and the converted image subjected to the first image conversion while making the conversion information and the converted image correspond to each other.

22. A computer program product having a computer readable medium including programmed instructions, wherein the instructions, when executed by a computer, cause the computer to perform:
acquiring conversion information determined based on a relationship between an original image and a converted image obtained by performing an image processing on the original image, and the converted image;
obtaining an output image by performing an image conversion on the converted image using the conversion information acquired; and
output the output image subjected to the image conversion.
